(19) United States
(12) Patent Application Publication
(10) Pub. No.: US 2019/0041154 A1
(43) Pub. Date: Feb. 7, 2019

(54) Sound Wave Absorption Module and Device Comprising Same

(71) Applicant: FCD, Laburgade (FR)

(72) Inventor: Florent Cheinet, Laburgade (FR)

(73) Assignee: FCD, Laburgade (FR)

(21) Appl. No.: 16/074,590

(22) PCT Filed: Nov. 22, 2016
(86) PCT No.: PCT/FR2016/053055

§ 371 Date: Aug. 1, 2018

(30) Foreign Application Priority Data
Feb. 2, 2016 (FR) 1650796

(51) Int. Cl. F41A 21/30; G10K 11/16; F41A 21/32; G10K 11/172

(52) U.S. Cl. CPC F41A 21/30; G10K 11/172; F41A 21/32; G10K 11/161

(57) ABSTRACT

The sound wave absorption module (1) comprises a perforated central conduit (20) in which a sound wave is intended to propagate, a casing (10) extending at a distance from and facing the central conduit, in a coaxial manner, an absorption chamber (40) partially delimited by the central conduit and the casing, and a resiliently deformable pocket (30) positioned in the absorption chamber in such a way as to at least partially surround the central conduit, the pocket containing an absorption fluid (31).

The invention relates to a sound wave absorption module, as well as a device comprising same as a silencer.

In the scope of handgun or barrel type firearms, the projectile, whether a bullet or a shell, exiting the barrel of the weapon produces a sound wave, called a muzzle wave, forming the detonation. This muzzle wave is an air pressure wave produced by the projectile which pushes the air outside of the barrel: when the air thus pushed exits the end of the barrel, it expands suddenly and creates this detonation.

It is possible to decompose this muzzle wave as a sum of Dirac of variable wavelengths. Indeed, the muzzle wave is an instantaneous event, without continuity, of which the amplitude is very high over a very short time, then disappears. In addition, the muzzle wave is dependent on the dimensions and forms of the head of the projectile pushing air outside of the barrel. In order to reduce the detonation heard as much as possible, it is necessary to optimally absorb the maximum amount of sound waves forming the muzzle wave thus generated.

Currently, there are sound wave absorption devices, as there are muzzle wave absorption devices, positioned at the outlet of the barrel of the weapon and comprising a perforated central conduit in which the muzzle wave (and the projectile) propagates, a casing extending at a distance and facing the central conduit in a coaxial manner, and an absorption chamber partially delimited, by the central conduit and the casing. The absorption chamber thus comprises a sound wave absorber like air (the device thus forms a single hollow cylinder), or a flexible material like rockwool or any other foam type material, or a solid absorber like a pile of metal sound deflectors like slightly curved metal discs.

However, current sound wave absorption devices are not completely satisfactory:

They definitively conform to one single type of projectile, it is therefore necessary to have several of them adapted to each type of projectile used. This increases the bulk and the number of sound wave absorption devices to transport for a shooter.

They are heavy and decrease the handling of the weapon in the case of a handgun, as for a rifle or a pistol.

An aim of the invention is to provide a module, and therefore a device, for absorbing a sound wave which is simple to use, adaptable, while being light and not very bulky.

To this end, a sound wave absorption module is provided, according to the invention, comprising a perforated central conduit in which a sound wave is intended to propagate, a casing extending at a distance and facing the central conduit in a coaxial manner, an absorption chamber partially delimited by the central conduit and the casing, and a resiliently deformable pocket positioned in the absorption chamber in such a way as to at least partially surround the central conduit, the pocket containing an absorption fluid.

Thus, the module is simple. The removable resiliently deformable pocket is not very bulky and can be filled before use with a fluid like water from a bottle. This, in addition enables an adaptation to the flight of the absorption module. Thus, the module according to the invention is simple to use, adaptable, while being light and not very bulky.

Advantageously, but optionally, the absorption module according to the invention has at least one of the following additional technical characteristics:

the fluid is a liquid, in particular water;

the central conduit comprises a wall comprising crossing openings so as to put the absorption chamber and the central conduit in fluid communication;

the wall is at least partially formed by a rigid mesh net;

the pocket is made from a flexible plastic material; and,

the pocket is made from latex or silicone.

A sound wave absorption device is also provided, according to the invention, comprising a barrel in which a sound wave is intended to propagate, and a sound wave absorption module having at least one of the preceding technical characteristics, the central conduit forming the barrel.

Advantageously, but optionally, the absorption device according to the invention has at least one of the following additional technical characteristics:

the device comprises a series of sound wave absorption modules joined to each other such that the barrel is formed by a succession of central conduits of the modules;

the absorption modules have different dimensions, in particular different lengths and/or diameters; and,

each absorption module comprises, in the absorption chamber, an absorbing element selected from among a foam absorber, a solid absorber and a fluid absorber.

Other advantages and characteristics of the invention will appear during the description below of an embodiment. In the appended drawings:

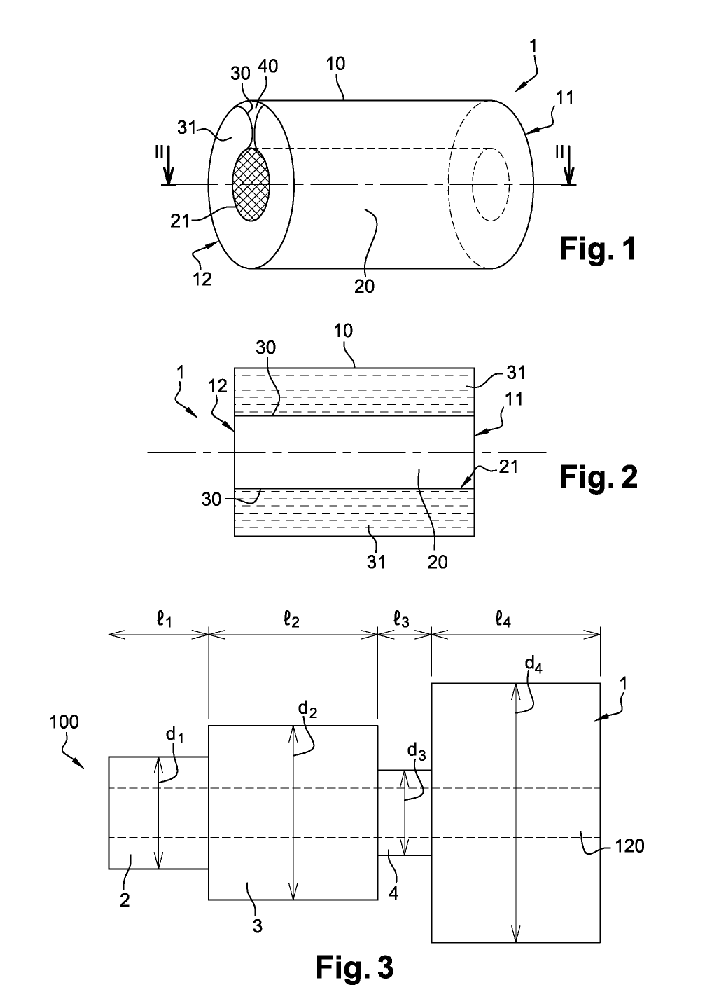

FIG. 1 is a schematic, three-dimensional view of a sound wave absorption module according to the invention;

FIG. 2 is a schematic, cross-section view according to II-II of the module in FIG. 1; and,

FIG. 3 is a side view of a sound wave absorption device according to the invention comprising a module according to FIGS. 1 and 2.

In reference to FIG. 1 and FIG. 2, an embodiment of a sound wave absorption module 1 according to the invention will be defined in detail. The sound wave absorption module 1 according to the invention is of a general cylindrical shape, here of revolution. It comprises an outer casing 10 comprising a first end 11 and a second end 12. The casing 10 externally delimits an absorption chamber 40. The absorption chamber is internally delimited by a perforated central conduit 20. The central conduit 20 is delimited by a wall 21. The wall 21 comprises through orifices enabling to establish a fluid communication between the central conduit 20 and the absorption chamber 40. A diameter of the central conduit 20 is greater, slightly, than that of a barrel on which it is installed. The perforations of the central conduit 20 made by the through orifices of the wall 21 enable the passage of the muzzle wave, generated during the expulsion of the projectile of the barrel, in the absorption chamber 40.

For example, the wall 21 is partially made by a rigid mesh net like a netting.

On the other hand, the sound wave absorption module 1 according to the invention comprises a resiliently deformable pocket 30. This pocket 30 is positioned so that it can be moved in the absorption chamber 40 in such a way as to fully or partially surround the central conduit 20. The pocket 30 is, prior to the positioning thereof within the absorption chamber 40, filled with a fluid 31. The fluid 31 is a liquid fluid having a viscosity adapted to the muzzle wave to be absorbed. Practically and simply, the fluid 31 is water. Indeed, a user of the sound wave absorption module 1 according to the invention can use water from the bottle thereof or from a water point nearby (pool, river, lake, etc.).

The pocket 30 is made from a flexible plastic material like a plastic bag, for example. As a variant of the embodiment, the pocket 30 is made from silicone or latex. For example, the pocket 30 is a condom.

The pocket 30 is this easily transportable and not very bulky.

During a use of the sound wave absorption module 1 according to the invention, the user fills the pocket 30 with a fluid 31. Then, they insert the pocket thus filled in the absorption chamber 40 by one 12 of the ends 11, 12 of the casing 10 which is open, the other end 11 being closed. Possibly, a closing cover (not represented) can be positioned on the open end 11 of the casing 10. The sound wave absorption module 1 according to the invention is thus ready to be positioned on a barrel.

Such a structure of the sound wave absorption module 1 according to the invention enables to use a more or less viscous liquid as a sound wave absorber. Indeed, liquids have a high absorption of sound wave energy. In addition, the structure of the sound wave absorption module 1 according to the invention has the advantage of being simple, easily adaptable to the muzzle wave to be absorbed, and consequently not very bulky.

In a first embodiment, a sound wave absorption device according to the invention 100 comprises one single sound wave absorption module 1 according to the invention. The sound wave absorption device according to the invention 100 comprises a barrel 120 which is formed by the central conduit 20 of the sound wave absorption module 1 according to the invention.

In a variant of the embodiment, illustrated in FIG. 3, the sound wave absorption device according to the invention 100 comprises a series of absorption modules 1, 2, 3, 4 joined to each other such that the barrel 120 is formed by a succession of central conduits of the sound wave absorption modules. Here, the series of absorption modules comprises four absorption modules 1, 2, 3, 4 of which one sound wave absorption module 1 according to the invention. The sound wave absorption module 1 according to the invention has a length 14 and an outer diameter d4. The second absorption module 2 has a length 11 and an outer diameter d1. The third absorption module 3 has a length 12 and an outer diameter d2. Finally, the fourth absorption module 3 has a length 13 and an outer diameter d3. The lengths 11, 12, 13 and 14, as well as the diameters d1, d2, d3 and d4 can be different from each other.

On the other hand, each one of the absorption modules comprise a casing and a central conduit both delimiting an absorption chamber. The absorption chamber of each one of the absorption modules comprises a sound wave absorber. The sound wave absorber is independently selected for each one of the absorption modules from among:

a pocket 30 filled with a fluid 31 to make a sound wave absorption module 1 according to the invention;

a solid absorber known per se as a pile of metal sound deflectors like slightly curved metal discs;

a flexible absorber comprising a flexible material like rockwool or any other foam type material, known per se.

The number and assembly order of the absorption modules to form the sound wave absorption device according to the invention 100 is not limited to the example given in FIG. 3.

Such a modularity in the types and dimensions of absorption modules and/or the number of absorption modules assembled to form the sound wave absorption device according to the invention 100 enables to optimally obtain a maximum absorption (or a reduction) of the muzzle wave generated by a given projectile for a given ejection speed.

Of course, it is possible to apply number modification to the invention, without moving away from the scope thereof.

1. Sound wave absorption module comprising:
a perforated central conduit in which a sound wave is intended to propagate;
a casing extending at a distance and facing the central conduit in a coaxial manner; an absorption chamber partially delimited by the perforated central conduit and the casing; and
a resiliently deformable pocket positioned in the absorption chamber in such a way as to at least partially surround the perforated central conduit, the resiliently deformable pocket containing an absorption fluid.

2. The sound wave absorption module according to claim 1, wherein the fluid is a liquid.

3. The sound wave absorption module according to claim 1, wherein the central conduit comprises a wall comprising crossing openings so as to put the absorption chamber and the central conduit in fluid communication.

4. The sound wave absorption module according to claim 3, wherein the wall is at least partially formed by a rigid mesh net.

5. The sound wave absorption module according to claim 1, wherein the resiliently deformable pocket is made from a flexible plastic material.

6. The sound wave absorption module according to claim 1, wherein the resiliently deformable pocket is made from latex or silicone.

7. A sound wave absorption device comprising:
a barrel in which a sound wave is intended to propagate; and
a sound wave absorption module comprising:
a perforated central conduit in which a sound wave is intended to propagate, wherein the central conduit forming at least a portion of the barrel;
a casing extending at a distance and facing the central conduit in a coaxial manner; an absorption chamber partially delimited by the perforated central conduit and the casing; and
a resiliently deformable pocket positioned in the absorption chamber in such a way as to at least partially surround the perforated central conduit, the resiliently deformable pocket containing an absorption fluid.

8. The sound wave absorption device according to claim 7, further comprising a second sound wave absorption module comprising a second central conduit, wherein the second sound wave absorption module is in series with and joined with the sound wave absorption module, wherein the barrel is formed at least in part from the central conduit and the second conduit.

9. The sound wave absorption device according to claim 8, wherein the sound wave absorption module and the second sound wave absorption module have different dimensions, in particular different lengths and/or diameters.

10. The sound wave absorption device according to claim 8, wherein the absorption module comprises, in the absorption chamber, an absorbing element, selected from the group consisting of a foam absorber, a solid absorber and a fluid absorber.

11. The sound wave absorption module according to claim 2, wherein the fluid is water.
